(19) United States
(12) Patent Application Publication
(10) Pub. No.: US 2009/0084772 A1
(43) Pub. Date: Apr. 2, 2009

(54) Heating Device for Dry Towel

(76) Inventor: Ming-Jen HSIAO, Tou Fen (TW)

Correspondence Address: Dr. BANGER SHIA, 102 Lindencrest Ct., Sugar Land, TX, 77479-5201, US

(21) Appl. No.: 11/862,393

(22) Filed: Sep. 27, 2007

(51) Int. Cl. H05B 1/00

(52) U.S. Cl. 219/385

(57) ABSTRACT

A heating device for dry towel includes a cylindrical outer casing containing a chamber; a container disposed in the chamber of the outer casing for receiving storage of one piece multiple pieces of towel, one or a plurality of heating band being disposed surrounding an outer wall of the container, the heating band being electrically connected to a power cord, the power cord extending to an outer side of the outer casing; and an upper lid covering up a top of the container. The container is heated up by the heating band to rise temperature of the air inside the container closed up with the upper lid for keeping towel lukewarm to provide more convenient and comfortable use particularly in bitter cold environment.

### BACKGROUND OF THE INVENTION

(a) Field of the Invention

The present invention is related to a heating device, and more particularly, to one to heat dry towel for keeping it warm and ready for use.

(b) Description of the Prior Art

As a necessity to one's daily life, towel has wide range of application. For example, one uses a piece of dry towel to wipe away sweats from his face or body. Heating devices generally available in the market are usually provided for heating damp towel. However, during winter time one may have cold due to residual water containment left on the skin after using a piece of warm but damp towel; meanwhile, direct use of a piece of dry towel under normal temperature to wipe away sweats may cause one feeling uncomfortable due to the cool air. Therefore, how to effectively heat a piece of dry towel (free of water containment) is an issue pending urgent solution in the manufacturing industry of towel heating systems.

### SUMMARY OF THE INVENTION

The primary purpose of the present invention is to provide a heating device for dry towel to correct the defects found with the prior art by supplying hot air to the dry towel for it to maintain lukewarm for its user to enjoy the convenience of refreshment.

To achieve the purpose, a heating device for keeping a piece of lukewarm towel includes a cylindrical outer casing containing a chamber; a container disposed in the chamber of the outer casing to receive placement of one piece or multiple pieces of dry towel having its outer wall disposed with one or a plurality of heating band electrically connected to a power cord to heat up the container with the power cord extending to an outer side of the outer casing; and an upper lid to cover up a top of the container. Wherein, the outer casing is comprised of a hollow cylinder and a lower cover to seal up a bottom of the cylinder. The outer casing is related to a cylinder made integrated with a bottom.

The lower cover is disposed at its center a locating hole; the container is comprised of the cylinder and its bottom; and a bolt fixed to and protruding from the bottom to engage with a nut through the locating hole.

The container is related to a bottomless, hollow cylinder.

The present invention allows convenient access for its user to a piece of lukewarm towel during cold days by the heating band disposed on the outer wall of the container to heat up the container thus to rise the temperature of the air inside the container closed up by the upper lid and the hot air maintains one piece or multiple pieces stored in the container in lukewarm status.

### BRIEF DESCRIPTION OF THE DRAWINGS

FIG. 1 is an exploded view of a preferred embodiment of the present invention.

FIG. 2 is a schematic view showing that the preferred embodiment of the present invention as assembled.

FIG. 3 is a sectional view of the preferred embodiment of the present invention.

FIG. 4 is a sectional view showing another preferred embodiment of the present invention.

FIG. 5 is a sectional view showing another preferred embodiment yet of the present invention.

### DETAILED DESCRIPTION OF THE PREFERRED EMBODIMENTS

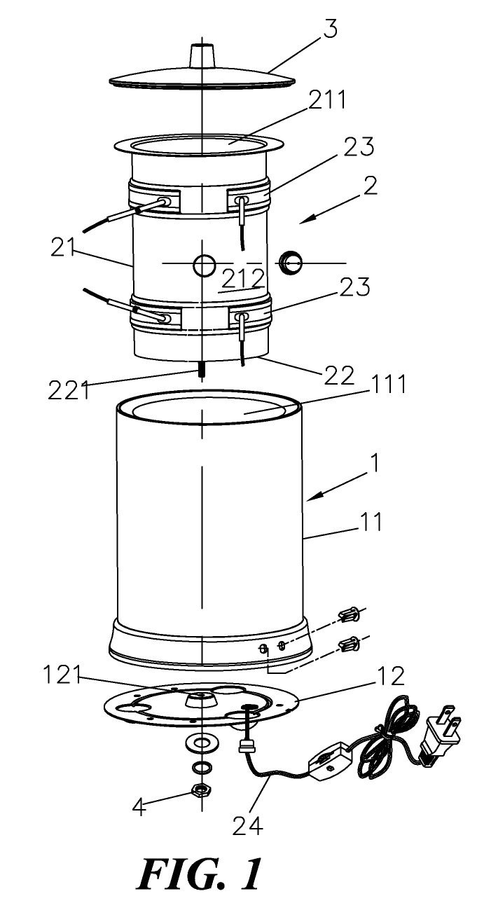

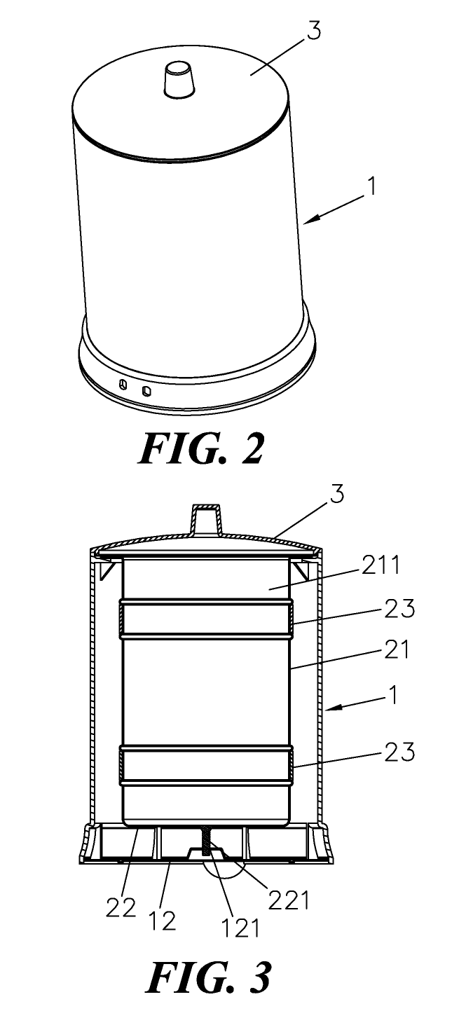

Referring to FIGS. 1, 2, and 3, a heating device for dry towel is essentially comprised of an outer casing 1, a container 2, and an upper lid 3.

Wherein, the outer casing 1 is made of refractory material and has a hollow cylinder 11 and a lower cover sealing up a bottom of the cylinder 11. The tube-shaped hollow cylinder 11 contains at its central portion a chamber 111 and a locating hole is disposed at a center of the lower cover 12.

The container 2 made of a metal material capable of heat transfer is located in the chamber 11 of the outer casing 1. The container 2 is comprised of a cylinder 21 and a bottom 22. One piece of multiple pieces of dry towel is received in a space 211 in the cylinder 21. Two heating bands 23 are respectively disposed surrounding an upper section and a lower section on an outer wall 212 of the cylinder 21 of the container 2. Both heating bands are electrically connected to a power cord 24 and the power cord 24 extends to an outer side of the outer casing 1 for connecting to a source of city power. A bolt 221 protruding from the bottom 22 is fixed to the bottom 22 and engaged with a nut 4 through the locating hole 121 on the bottom cover 12 of the outer casing 1.

The upper lid 3 covers up a top of the cylinder 21 of the container 2 so to close up the space 21 of the container 2.

To assemble, both heating bands wrap up the outer wall 212 of the cylinder 21 of the container 2; the power cord 24 is connected; the container 2 is inserted into the chamber 111 of the hollow cylinder 11 of the outer casing 1; the power cord 24 is then led to the outer side of the outer casing 1; the bolt 221 disposed on the bottom 22 of the container 2 passes through the locating hole 121 on the bottom cover 12 of the outer casing 1 and engages with the nut 4 to secure the container in position; and finally, the upper cover 3 covers up the top of the cylinder 21 of the container 2 to complete the assembly of a dry towel heating device of the present invention. A working principle of the present invention is to have one piece or multiple pieces of dry towel (free of water containment) placed in the space 211 of the container 2; the upper lid 3 to cover up the top of the cylinder 21; and the power cord 24 connected to the source for heating up both heating bands 23 attached to the outer wall 211 of the cylinder of the container 2 to further rise the air temperature inside the space 211 of the cylinder 21. The hot air is then supplied to the dry towel stored in the cylinder 21 for making lukewarm towel available for the user to enjoy more comfortable and convenient use of the towel particularly in bitter cold environment.

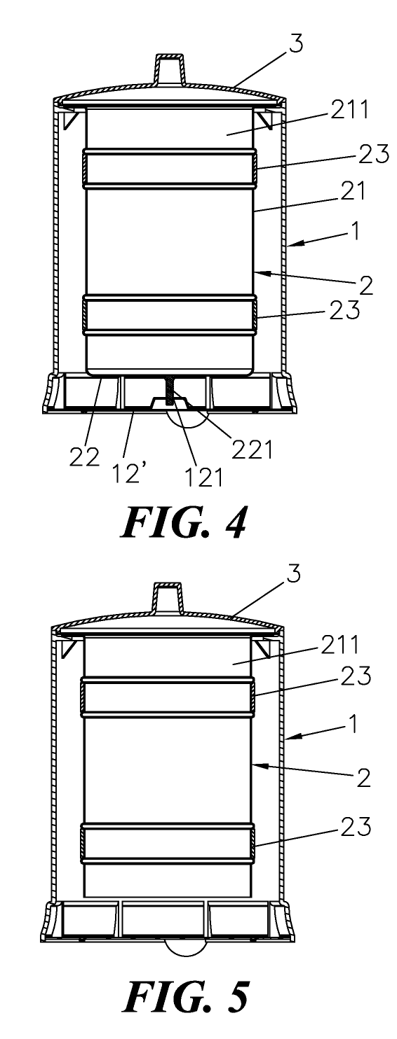

Alternatively, the outer casing 1 may be made in an integrated structure of a cylinder provided with a bottom 12′, which is not a separate member as disclosed in the first preferred embodiment as illustrated in FIG. 4 showing another preferred embodiment of the present invention. Furthermore, the container 2 disclosed in the first preferred embodiment may be made bottomless; instead, the bottom is replaced with the bottom/lower cover of the outer casing as illustrated in FIG. 5 showing another preferred embodiment yet of the present invention in the absence of the bolt, the nut, and the locating hole on the bottom or the lower cover of the outer casing.

The prevent invention provides an improved structure of a heating device of dry towel, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A heating device for dry towel comprising:
a cylindrical outer casing containing a chamber;
a container disposed in the chamber of the outer casing for receiving storage of one piece multiple pieces of towel, one or a plurality of heating band being disposed surrounding an outer wall of the container, the heating band being electrically connected to a power cord, the power cord extending to an outer side of the outer casing; and
an upper lid covering up a top of the container.

2. The heating device for dry towel as claimed in claim 1, wherein the outer casing is related to a hollow cylinder and a lower cover sealing up a lower end of the cylinder.

3. The heating device for dry towel as claimed in claim 1, wherein the outer casing is related to an integrated part of a cylinder with bottom.

4. The heating device for dry towel as claimed in claim 2, wherein a locating hole is disposed at a center of the lower cover; the container is comprised of a cylinder and a bottom; a bolt protruding from and fixed to the bottom; and the bolt is engaged with a nut through the locating hole.

5. The heating device for dry towel as claimed in claim 3, wherein a locating hole is disposed at a center of the lower cover; the container is comprised of a cylinder and a bottom; a bolt protruding from and fixed to the bottom; and the bolt is engaged with a nut through the locating hole.

6. The heating device for dry towel as claimed in claim 2, wherein the container is related to a hollow cylinder.

7. The heating device for dry towel as claimed in claim 3, wherein the container is related to a hollow cylinder.
